(19) United States
(12) Patent Application Publication
(10) Pub. No.: US 2026/0214400 A1
(43) Pub. Date: Jul. 23, 2026

(54) GENERATING VIBROTACTILE SIGNALS FROM AUDIO CONTENT FOR PLAYBACK OVER HAPTIC ACOUSTIC TRANSDUCERS

(71) Applicant: MERIDIAN AUDIO LIMITED, Cambridgeshire (GB)

(72) Inventors: Ethan STANHOPE, Huntingdon Cambridgeshire (GB); Laurence J. HOBDEN, Huntingdon Cambridgeshire (GB); Stephen G. OXNARD, Huntingdon Cambridgeshire (GB); Samuel J. R. SMITH, Huntingdon Cambridgeshire (GB); Michael P. COUSINS, Huntingdon Cambridgeshire (GB)

(21) Appl. No.: 19/138,419

(22) PCT Filed: Dec. 13, 2023
(86) PCT No.: PCT/GB2023/053211

§ 371 Date: Jun. 12, 2025

(30) Foreign Application Priority Data
Dec. 14, 2022 (GB) 2218898.1

(51) Int. Cl. H04S 3/00; G06F 3/16; H04R 5/02; H04S 7/00

(52) U.S. Cl. CPC H04S 3/008; G06F 3/165; H04R 5/02; H04S 7/307; H04S 2400/01; H04S 2400/03

(57) ABSTRACT

A method of generating one or more tactile driving signals from an input signal representative of real-time audio is provided. Transient extraction processing is performed on the input signal to determine a transient component of the real-time audio and complementary transient and steady state tactile signals are generated in dependence on the transient extraction processing. The transient and steady state tactile signals are then used to generate one or more tactile driving signals which can be used to drive one or more haptic actuators. An audio system is also provided comprising one or more digital signal processors adapted to perform the method. The system may comprise one or more haptic actuators driven by the generated tactile driving signals.

### FIELD OF INVENTION

The present invention relates to the derivation and manipulation of driving signals for vibrotactile acoustic transducers, particularly when mounted in a seat, to enhance and/or augment the reception of a traditional audio loudspeaker system as a multi-sensory experience.

### BACKGROUND TO THE INVENTION

Haptics (from the Greek word haptikos, meaning “pertaining to the sense of touch”) seen in T. Jaiswal, R. Yadav and P. Kedia, “Haptic Technology—Comprehensive Review Study with its Applications,” International Journal of Advance Research in Science and Engineering, April 2018 is a form of technology where the application of force is used to simulate the sensation of touch. This technology is commonly applied in the gaming, virtual reality (VR), and cinema industries, largely through rumble effects rendered over acoustic transducers mounted in objects in direct tactile contact with the user (such as gaming controllers, wearable devices or seats) to enhance the rendered sensory experience. As these rumble effects can increase the immersion of cinematic and VR experiences, tactile feedback can also be used to augment the experience of a musical rendition.

When experiencing music at a high sound pressure level (SPL) a listener will be able to feel a tactile sensation from the lower frequencies of the audio being rendered in the form of vibrations. It is desirable to re-create this sensation in home and automotive audio solutions using seat mounted or wearable acoustic transducers to augment the listening experience. It is generally accepted that humans can hear frequencies ranging from 20 Hz to 20,000 Hz. As stated in B. Remache-Vinueza, et al., “Audio-Tactile Rendering: A Review on Technology and Methods to Convey Musical Information through the Sense of Touch,” Sensors, September 2021, humans can sense vibrations of frequencies ranging from 0.3 Hz up to 1,000 Hz.

As seen in FIG. 1, there is overlap 13 between the audible frequency spectrum 12 and haptic sensory range 11, meaning that an audio signal containing content in this overlapping frequency range could be rendered over seat or body mounted acoustic transducers to provide haptic augmentation to the input audio. This approach, however, can sound unnatural to a listener as various regions of the body have ranging sensitivities to tactile stimuli.

In the first instance, a method of creating a more natural haptic performance is to perform time alignment between the traditional acoustic transducers performing the audible portion of the signal and the haptic actuators rendering the tactile feedback. A delay line can be introduced to correct the temporal mismatch, which can be caused by the positions of the various transducers in space and their relative proximity to the listener, as well as varying latency through different sections of the audio system. Improving the temporal alignment of haptic and sonic responses benefits the perceived cohesion of the overall system, however further gains, by way of signal manipulation, can be achieved to create a more convincing tactile experience.

Although humans can experience the tactile sensation of vibration up to 1,000 Hz, it is not practical for haptic actuators to render up to such a high frequency. Mechanoreception is the ability of a human to detect stimuli such as changes in pressure and the sensation of touch, using mechanoreceptors, which are a type of nerve ending. One of the main mechanoreceptive channels of the somatosensory system (also known as the somatic senses such as tactile perception) responsible for perceiving vibration is the Pacinian channel. The Pacinian corpuscle is a nerve ending responsible for the skin's sensitivity to vibration, which has a sensitivity range of 40 Hz to 500 Hz from Birnbaum D. M., Wanderley M. M. A Systematic Approach to Musical Vibrotactile Feedback; Proceedings of the International Computer Music Conference; Copenhagen, Denmark. 27-31 Aug. 2007; pp. 397-404, meaning that the frequency response of a haptic actuator can be band-limited to this range.

As the human ear is most sensitive to frequencies above 250 Hz (see e.g. H. Fletcher, and W. A. Munson, “Loudness, its definition, measurement and calculation”, Journal of the Acoustical Society of America 5, 1933, pp. 82-108), it is useful for the acoustic transducers to only render haptic signals below this value to avoid distracting from the sonic performance of the other parts of the audio system. Therefore, a potential frequency range of interest for haptic augmentation is 40 Hz to 250 Hz.

As proposed in Y. Cho, et al., “Haptic Cushion: Automatic Generation of Vibro-tactile Feedback Based on Audio Signal for Immersive Interaction with Multimedia”, International Conference on New Actuators, 2014, and also seen in published U.S. Pat. No. 11,340,704 B2, synthesis of new signals informed by the original audio can be used to generate haptic data over a desired frequency range. However, the generation of new content can be seen as over embellishment of the original audio, where it is possibly not appropriate.

It has been shown in A. Sonza, et al., “A whole body vibration perception map and associated acceleration loads at the lower leg, hip and head,” Medical Engineering and Physics, 2015, that different regions of the body have different perceptual sensitivity to vibration. As such, it is useful for a tactile rendering system to be able to distribute and weight different levels of haptic signals to different regions of the system in contact with the body to accommodate for varying sensitivity ranges.

Bone conduction is another consideration for haptic systems, as seen in Sakuragi R., Ikeno S., Okazaki R., Kajimoto H. “CollarBeat: Whole Body Vibrotactile Presentation via the Collarbone to Enrich Music Listening Experience”; Proceedings of the International Conference on Artificial Reality and Telexistence and Eurographics Symposium on Virtual Environments, 2015. Bone conduction can be an influencing factor on the perception of tactile sensations, and thus is it useful to be able to weight different signals to drivers in close proximity to areas of the body where the effect of bone conduction will be more or less prominent.

The decomposition of the signal and treatment of individual elements is important for advanced control of the haptic experience. As seen in U.S. Pat. No. 11,340,704B2, artificial intelligence (AI) can be used to extract harmonic components and percussive sounds and treat them separately. However, using AI can be detrimental as it may take up a large amount of processing which can be an issue when the capabilities of a digital signal processor (DSP) are limited, and the AI must be trained on an extensive list of programme material encompassing varied genres of audio to be rendered through the system, which can be time consuming and expensive. Moreover, there exists the potential for such AI training to be carried out on a finite range of programme material, thus raising the issue that some genres may be omitted to the detriment of the overall performance, for example, when rendering more obscure audio.

The temporal aspects of audio signals can be categorised into transient and steady-state signals. Following J. O. Smith, “Introduction to Digital Filters with Audio Applications,” W3K Publishing, October 2007, ISBN 978-0-9745607-1-7, a transient event may be defined as a sudden wideband event in an otherwise steady-state signal. Transient events can also be categorised as events in a signal where the broadband energy of the signal, or the energy of a specific frequency range, changes rapidly. This definition is sufficient for creating algorithms to track transient events. An example of such a transient event can be seen in FIG. 2 against an otherwise steady state background.

Transient events can be felt by an individual as a punching sensation, whilst steady state signals can be interpreted as a rumble effect in a tactile system. It can therefore be useful to separate the transient signal from the steady state signal in an audio stream that is to be rendered over haptics.

As, the onboard processing capabilities of a DSP can be limited, such as for instance when this technology is used for the augmentation of infotainment systems within the automotive industry, it is desirable to create a lightweight solution to derive the tactile signals from an incoming audio stream in real-time. It is important that this technology is computationally inexpensive so that the process can be executed on the onboard DSP of an automotive vehicle.

There is therefore a need for an improved method of deriving tactile signals from incoming audio stream that is computationally efficient whilst allowing for more refined haptic feedback that can be used to enhance and/or augment the audible reception from a traditional audio loudspeaker system to provide a multi-sensory experience.

### SUMMARY OF THE INVENTION

According to one aspect of the present invention, a method of generating one or more tactile driving signals from an input signal representative of real-time audio, the method comprising the steps of:
receiving the input signal;
performing transient extraction processing on the input signal to determine a transient component of the real-time audio;
generating a transient tactile signal T(t) and a steady state tactile signal S(t) from the input signal in dependence on the transient extraction processing, wherein the transient tactile signal and the steady state tactile signal are complimentary such that S(t)+T(t)=I(t), where I(t) is the input signal on which transient extraction processing was performed; and,
generating the one or more tactile driving signals in dependence on one or both of the transient tactile signal and the steady state tactile signal.

Thus, the invention provides a method for generating complimentary transient and steady-state tactile signals from a real-time audio stream utilising transient analysis to estimate when a transient event has occurred. The transient and steady-state tactile signals are then used to generate one or more tactile driving signals, which can be used to drive haptic actuators.

There are several ways in which the transient extraction analysis may be performed, but broadly speaking a transient estimation value can be expressed as the relationship between a short term (micro) dynamic envelope typically of time frame (0 ms-100 ms) and a longer term (macro) dynamic envelope of typical time frame (200 ms-1000 ms).

The received input audio stream may be passed through an algorithm to derive a transient estimation value, which is preferably constrained between the values of 0 and 1. A metric derived from the so-called “crest factor” satisfies this requirement, providing a relationship between the peak and the effective, or root mean square (RMS), values of the signal. The transient estimation value analyses the relationship between the magnitude of the instantaneous peak of the real-time audio stream and the average magnitude in a previous time frame of audio, outputting a higher value when a transient is detected.

Therefore, in preferred embodiments, performing transient extraction processing comprises deriving a real-time transient estimation value C(t) from the input signal, wherein C(t) has values in the range 0≤C(t)≤1 and is representative of the transient component of the real-time audio; and the transient tactile signal T(t) is generated according to T(t)=C(t)I(t) and the steady-state tactile signal S(t) signal is generated according to S(t)=(1−C(t))I(t).

The transient estimation value may then be used to create a transient tactile signal, for example by multiplying with the received input audio signal. The compliment of the derived transient estimation signal can then be multiplied with the same band-limited audio signal to create the steady-state tactile signal. If these signals were to be summed together, they should recreate the audio signal from which they were derived. This allows the system to control the exaggeration or diminishment of transient or steady state elements of the audio stream, avoiding embellishment or colouration and maintaining transparency.

Preferably, the input audio signal is frequency band-limited prior to the transient estimation step. Such band-limiting may be performed before reception of the input signal or after its reception. The chosen band-limiting will typically be informed by a haptic actuator drive unit frequency response as well as psychoacoustics and the perception sensitivity of the somatosensory system. For example, the band-limiting may be in the frequency range 40 to 250 Hz for optimal tactile response.

The generated tactile driving signals can be distributed to a multitude of haptic actuators. This distribution is informed by factors such as transducer response, drive unit location and other user-controlled parameters. An actuator may receive only the transient signal, only the steady-state signal, or a weighted sum of both signals.

These generated signals can be derived from a mono audio stream, or alternatively, the process can be applied to any number of discrete audio streams in real time, creating a transient and a steady state tactile signal for each channel of audio.

The method may further comprise generating one or more acoustic driving signals in the audible frequency range in dependence on the input signal. In this way, both audible and tactile driving signals are generated which can be used to drive appropriate transducers, providing a user with a rich combination of audio and haptic sensory feedback.

According to a second aspect of the present invention, a computer readable medium comprises computer executable instructions which, when executed on one or more processors of an audio system, causes the system to perform the method of the first aspect. In this way the method of the first aspect of the present invention can be implemented by one or more processors of an audio system to generate tactile driving signals for driving haptic actuators.

The computer readable medium of the second aspect of the invention may provide an update or enhancement to an existing digital signal processor sound source system. In this way an existing system can be updated by providing an update.

According to a third aspect of the present invention, an audio system comprises one or more digital signal processors which are adapted to perform the method of the first aspect.

In some embodiments the audio system comprises a user interface for receiving user input parameters. In this way, the user may control certain characteristics of the tactile driving signals.

Preferably, the audio system comprises one or more tactile transducers for providing haptic feedback, each of the tactile transducers driven by a tactile driving signal of the one or more tactile driving signals. Each tactile driving signal may be generated for optimally driving its respective tactile transducer.

In some embodiments, the one or more of the tactile transducers are adapted for use in a seat to be occupied by a user. The tactile transducers may be located in the backrest, under seat, and leg regions of the seat. Further tactile transducers may be provided for the floor. In other embodiments tactile transducers are adapted for use in a wearable device to be worn by a user According to the particular application, specific patterns of actuators may be provided for optimal sensory feedback, with the driving signal appropriately attuned.

The audio system may further comprise one or more acoustic transducers for providing audible signals, each of the acoustic transducers being driven by an acoustic driving signal of the one or more acoustic driving signals. In this way, both acoustic and tactile transducers are provided, allowing a user to experience a rich combination of audio and haptic sensory stimulation optimized for the particular arrangement and audio type.

As will be appreciated by those skilled in the art, the present invention is capable of various implementations according to the application.

### BRIEF DESCRIPTION OF THE DRAWINGS

Examples of the present invention will be described in detail with reference to the accompanying drawings, in which:

FIG. 1 shows a frequency-domain representation of a piece of audio with the overlap between the haptic sensory region and audible acoustic region defined;

FIG. 2 shows a time-domain representation of transient events occurring in an otherwise steady state audio stream;

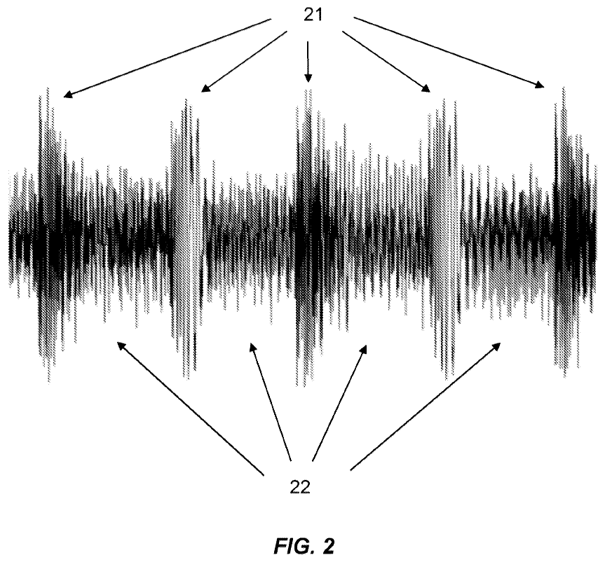

FIG. 3 illustrates an exemplar setup of an automotive vehicle seat with one acoustic transducer mounted in the backrest of the seat;

FIG. 4 is a flow chart showing the high-level transient processing of an audio signal;

FIG. 5 shows time-domain analysis of a mostly steady state signal containing a transient, with (a) the original signal, (b) a real-time transient estimation value, (c) the calculated transient signal, and (d) the calculated steady state signal;

FIG. 6 is schematic representation of the process applied in the time domain analysis of FIG. 5;

FIG. 7 is a flow chart showing more detail of required and optional processing steps where the transient and steady state streams are combined before output;

FIG. 8 is a flow chart showing more detail of required and optional processing steps where the transient and steady state streams are not combined before output;

FIG. 9 illustrates an example configuration of a seat with two internally-mounted haptic transducers, one in the backrest and one beneath the seat; and,

FIG. 10 illustrates an example configuration of a seat with multiple smaller haptic transducers mounted in the backrest, a large actuator below the seat, a leg actuator, and a floor shaker.

### DETAILED DESCRIPTION

The present invention may be employed in a number of different ways according to the audio system being used. The following describes some example implementations with reference to the figures.

The invention derives a transient haptic signal and a steady state haptic signal from audio source content in real-time and distributes these signals to one or more acoustic transducer. Embodiments of this invention are used to augment the experience of audio systems to create an authentic tactile sensation which is coherent with the aural reception of sound.

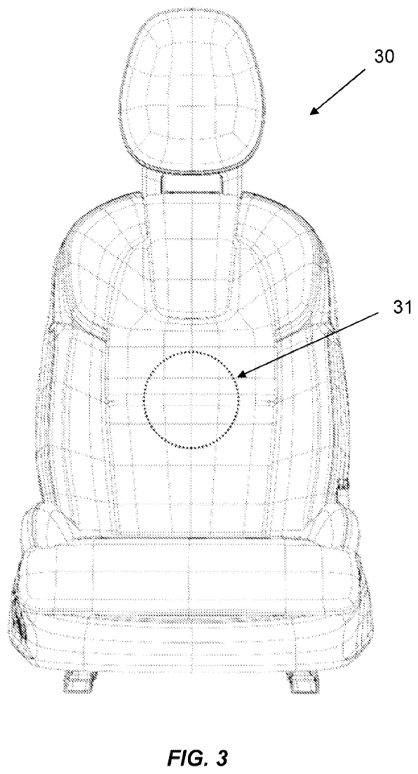

The motivation to separate the transient and steady state haptic streams from the original source audio stems from both user-experience and transducer mechanical design considerations. FIG. 3 depicts a basic arrangement which incorporates a single transducer 31 mounted to the backrest of a seat 30, although the transducer could be located and mounted at will depending on the use case. In this instance, the single transducer should be capable of effectively reproducing both steady state and transient haptic content.

It is common that actuators employ a heavy moving mass in order to facilitate high energy transfer at low frequencies, but this in turn can result in a slower and weaker transient response. Conversely, lighter moving mass actuators may possess sufficiently fast transient responses but may then fail to provide sufficient energy at low frequencies when driven with an untreated input audio signal. Hence, it is beneficial to be able to weight the transient or steady state elements present in the driving signal in order to accommodate actuator responses which can differ from design to design. Furthermore, it is also advantageous to be able to control the balance of steady state (rumble) and transient (punch) components in the interests of user-experience, such that the blend of the two differing resulting sensations may be tuned to taste and also calibrated for different audio programme material.

For the purposes of the invention, audio signals containing a full range of acoustic frequencies can be processed to determine the transient and steady state components. However, it is generally preferable that audio signals are band-limited to a frequency region of interest prior to processing. Sometimes, the audio signal may be naturally band-limited. Otherwise, it may be desirable to band-limit the audio signal by frequency filtering to the operable frequency region of interest.

A rudimentary approach to prepare the band-limited signal is to apply a low pass filter to an input audio signal with a cut-off frequency in the region of 1 kHz, resulting in band-limited signals with frequency content consistent with the limits of the human tactile sensation response, see B. Remache-Vinueza, et al., “Audio-Tactile Rendering: A Review on Technology and Methods to Convey Musical Information through the Sense of Touch,” Sensors, September 2021.

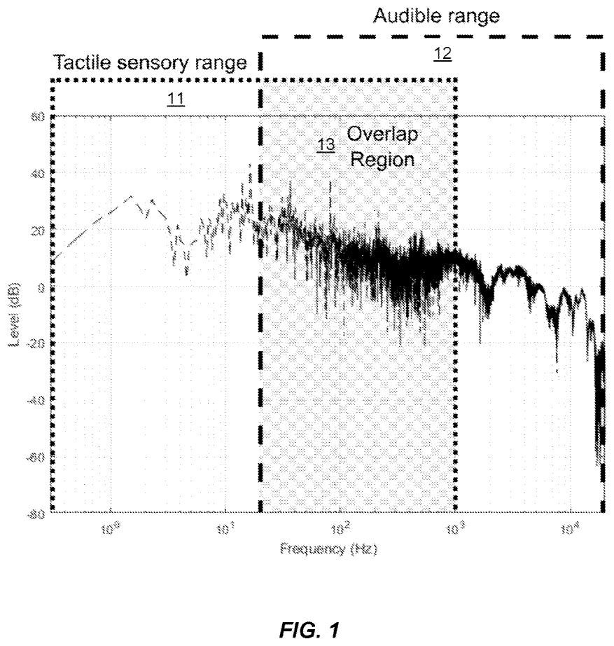

A more considered approach to deriving band-limited signals accounts for the response of both aural and tactile sensations in humans under the influence of sonic phenomena across frequency. As previously described, following the discussion in B. Remache-Vinueza, et al., “Audio-Tactile Rendering: A Review on Technology and Methods to Convey Musical Information through the Sense of Touch,” Sensors, September 2021, FIG. 1 depicts the overlap region 13 in the human response with frequency that exists between the tactile response region 11 and the aural response region 12 to a piece of audio, whereby so-called subsonic phenomena (i.e. f<20 Hz) may be sensed by tactile means, frequencies in the range 20 to 1 k Hz may be sensed by both tactile and aural means, whereas the human tactile response becomes ineffective for frequencies greater than 1 KHz.

Additionally, the primary mechanism for tactile vibratory sensation via skin contact is by means of the Pacinian channel which has an effective response to haptic phenomena between 40 and 500 Hz, seen in Birnbaum D. M., Wanderley M. M. “A Systematic Approach to Musical Vibrotactile Feedback”; Proceedings of the International Computer Music Conference; Copenhagen, Denmark. 27-31 August 2007; pp. 397-404. Furthermore, the human ear becomes increasingly sensitive to sonic phenomena for frequencies greater than 250 Hz (see e.g., H. Fletcher, and W. A. Munson, “Loudness, its definition, measurement and calculation”, Journal of the Acoustical Society of America 5, 1933, pp. 82-108).

Drawing on these considerations, preferred implementations of the present invention include the derivation of band-limited signals that exist in the frequency range of 40-250 Hz. This band-limiting enables effective haptic response excitation while reducing the potential for the haptic actuator output(s) to detract from the quality of the aural reception of sound within the complete system.

In some cases, for instance in multi-channel audio content, a low-frequency effects (LFE) channel may contain an appropriate frequency range to drive haptic actuators and provide tactile feedback. In these instances, the LFE channel or similar audio content containing frequencies within the human tactile perception range can be used as the input audio-tactile signal for this processing.

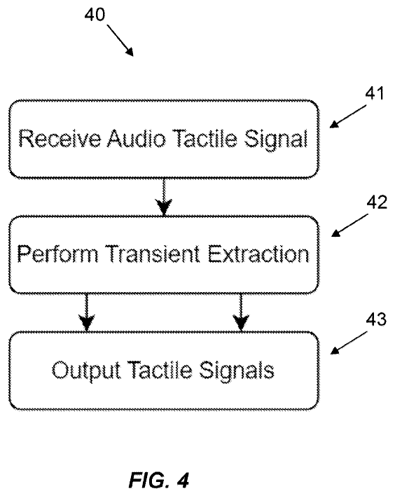

The resulting band-limited input signal is subject to analysis in order to calculate the aforementioned transient and steady state haptic streams. There are several ways in which such analysis may be performed, but broadly speaking a transient estimation value can be expressed as the relationship between a short term (micro) dynamic envelope typically of time frame (0 ms-100 ms) and a longer term (macro) dynamic envelope of typical time frame (200 ms-1000 ms). This processing represents the core of the invention, and a flow diagram 40 of the overall methodology is shown in FIG. 4. The received input audio signal 41 is subject to transient extraction processing 42 and the resulting tactile driving signals are output 43.

To this end, the relationship between the peak and the effective, or root mean square (RMS), values calculated from the band-limited input signal can be ascertained. A useful definition for such a relationship is the crest factor, which is equivalent to the peak to average power ratio (PAR) of the signal, when expressed in decibels, as defined in T. J. Rouphael, “Wireless 101: Peak to average power ratio (PAPR),” 2009 (which is available online at: https://www.eetimes.com/wireless-101-peak-to-average-power-ratio-papr/, accessed: Jul. 27, 2022), as follows:

$$C ( t ) = P A R ( t ) = 10 {log}_{10} ( \frac{{P}_{peak} ( t )}{{P}_{avg} ( t )} ) dB ; {P}_{peak} ( t ) \geq {P}_{avg} ( t )$$

where Pₚₑₐₖ is the maxima of the squared audio signal within some time frame of the signal and P_{avg} is the average of the squared signal as calculated over the same time frame interval.

Although the above provides one example method to derive a transient estimation value, such a value can be calculated using other methods, providing that it represents a relationship between peak and average signal values and is reducible to a mapped range from 0 to 1. For instance, a transient estimation value C(t) could be derived by the following relationship:

$$C ( t ) = \sqrt{{P}_{peak} ( t )} - \sqrt{{P}_{avg} ( t )} ; {P}_{peak} ( t ) \geq {P}_{avg} ( t ) ; {P}_{peak} , {P}_{avg} ∈ [ 0 : 1 ]$$

In all instances of this calculation, Pₚₑₐₖ(t) and P_{avg}(t) will be bounded between 0 and 1, as the original signal will be an audio signal of amplitude range −1 to 1, representing Full Scale audio. Therefore, the transient estimation value C(t) will also be bounded between 0 and 1, which is particularly beneficial as a scaling factor.

Using such a transient estimation value C(t), as described above, two complementary audio tactile signals can be generated as follows:

$$T ( t ) = C ( t ) I ( t )$$

$$S ( t ) = ( 1 - C ( t ) ) I ( t )$$

$$∴ S ( t ) + T ( t ) = I ( t )$$

where T(t) is a transient tactile signal, S(t) is a steady-state tactile signal, and I(t) is the input audio signal on which the transient extraction processing was performed, allowing for any filtering before processing. In this way, the two complimentary tactile signals contain all the relevant information from the input signal.

The time frame for the calculation of peak and effective values can be adjustable. With smaller dynamic envelope time frames for the peak and RMS tracking, the C(t) value will become more responsive to smaller changes in the signal. With a longer time frame, the resultant transient estimation value will be smoother, thus representing the more prominent transient events in the signal.

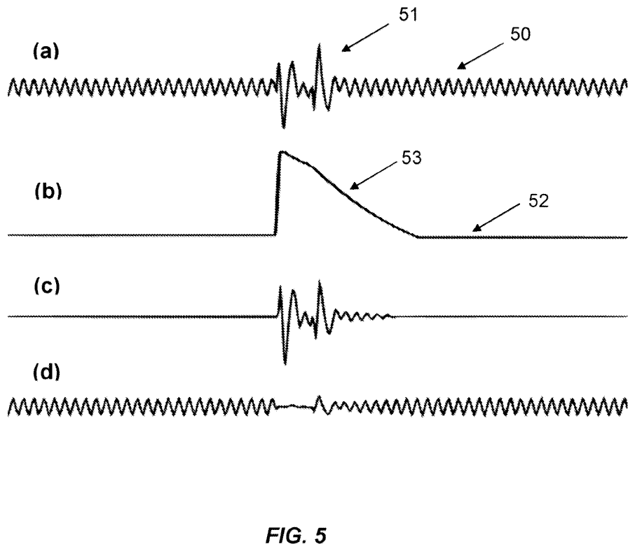

FIG. 5 illustrates the process in the time domain, starting with the input signal shown in FIG. 5(a), which is an ostensibly steady state input signal 50 with a transient 51 inserted into it. Applying transient extraction processing to this signal yields the transient estimation value C(t) shown in FIG. 5(b), with the central “sawtooth” characteristic 53 representing the transient against a broadly constant zero background level 52. Multiplying the input signal by C(t) yields the transient tactile signal T(t) shown in FIG. 5(c), whilst multiplying the input signal by 1−C(t) yields the steady state tactile signal S(t) shown in FIG. 5(d).

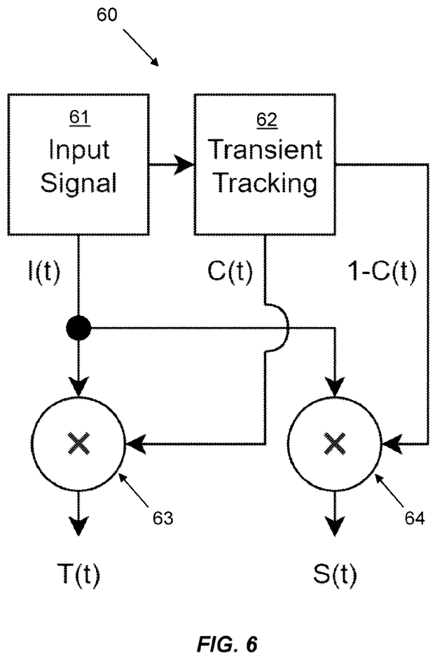

FIG. 6 shows schematically the steps involved in this process 60, starting with the input signal 61 on which the transient tracking analysis 62 is performed, resulting in the transient estimation value C(t) and its compliment 1−C(t), which are then multiplied by the input signal at 63 and 64 respectively to generate the transient tactile signal T(t) and the steady state tactile signal S(t).

Additional arithmetic can be used to manipulate the C(t) signal, such as squaring it or gaining it to alter the intensity of its response, but it is useful to note that the range of the signal should be constrained to the range between 0 and 1. Any functional equivalent to the above process can likewise lead to representative transient and steady state tactile signals.

Once the transient and steady state tactile signals have been derived, they can be used to generate one or more tactile driving signals for use in driving one or more tactile actuators. The individual transient and steady state tactile signals may be used individually as driving signals, with or without further processing, but they may also be combined to generate a tactile driving signal

For example, the signal Aᵢ(t) to be sent to the i^{th} actuator can be represented by the following equation:

$${A}_{i} ( t ) = {G}_{s {s}_{i}} S ( t ) + {G}_{t {r}_{i}} T ( t )$$

where Gₛₛ_{ᵢ} is the steady state gain (or weighting) of the tactile driving signal for the i^{th} actuator, Gₜᵣ_{ᵢ} is the transient gain (or weighting) of the i^{th} actuator, T(t) is the time domain representation of the transient signal extracted from the original audio, and S(t) is the time domain representation of the steady state signal extracted from the original audio. In some embodiments the steady state and transient gain values may be fixed and optimised according to the tactile actuator to be driven, whilst in other embodiments the gain values may be varied, for example by user input.

In one implementation, the steady state and transient gain values can be represented by:

$${G}_{s {s}_{i}} = 1 {0}^{\frac{- u b}{20}} + {W}_{s {s}_{i} ;} u ∈ [ - 1 : 1 ]$$

$${G}_{{tr}_{i}} = {10}^{\frac{u b}{20}} + {W}_{{tr}_{i}} ; u ∈ [ - 1 : 1 ]$$

where u is a user input parameter, having a value between −1 and 1, b is a static scaling factor that controls the strength of the user parameter, and Wₛₛ_{ᵢ} and Wₜᵣ_{ᵢ} are the static weighting values for the steady state and transient signals, respectively, for the i^{th} actuator.

When u=0, the steady state and transient gains are direct pass throughs of the static weighting values. When u is positive, the level of the transient signal will be increased and the level of the steady state signal will be diminished, each by a decibel value equal to ub, since b represents a logarithmic decibel gain in this implementation. In other implementations, where b represents a linear gain, the user-controlled components

$$10 \frac{- ub}{20} and 10 \frac{ub}{20}$$

could be replaced by ub and 1/ub.

Depending on the application, the transient and steady state tactile signals may be subject to filtering and/or temporal correction either before or after the weighting is applied. The ordering and application of such processing can be done in the most efficient manner for a given situation.

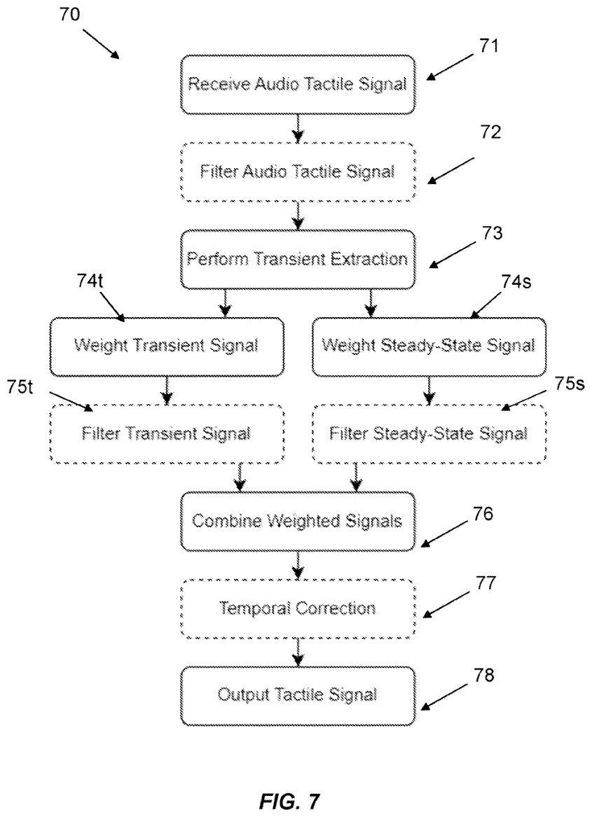

FIG. 7 is a flow chart showing the process steps 70 according to embodiments in which the transient and steady state tactile signals are combined to generate one or more tactile driving signals. The primary steps are shown in solid boxes, whereas the optional steps are shown in dashed boxes. The received input signal 71 is optionally filtered 72 to extract tactile frequency components prior to performing the transient extraction analysis 73. The resulting transient and steady state tactile signals are weighted 74t, 74s and optionally further filtered 75t, 75s prior to summation 76. Temporal correction 77 may then be applied to the combined signal prior to outputting the one or more tactile driving signals 78.

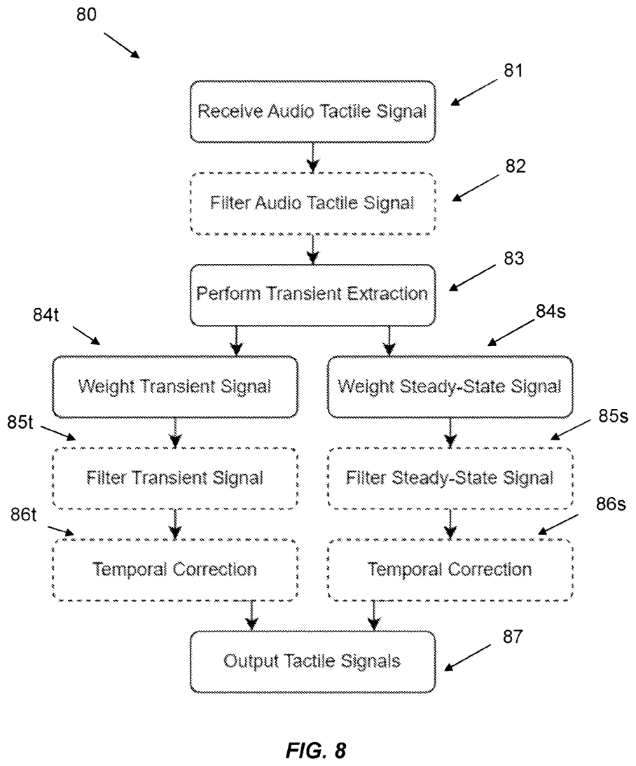

FIG. 8 is a flow chart showing the process steps 80 according to embodiments in which the transient and steady state tactile signals are not combined to generate one or more tactile driving signals. The primary steps are again shown in solid boxes, whereas the optional steps are shown in dashed boxes. The received input signal 81 is optionally filtered 82 to extract tactile frequency components prior to performing the transient extraction analysis 83. Appropriate weighting 84t, 84s is then applied to the resulting transient and steady state tactile signals, after which further filtering 85t, 85s and/or temporal correction 86t, 86s may optionally be performed prior to outputting the one or more tactile driving signals 87 without summation.

Having reviewed the input signal analysis and tactile driving signal generation, we now move on to consider the configurations and properties of haptic actuators that may be driven in embodiments of the invention. As previously described, FIG. 3 shows is a single acoustic transducer 31 mounted in the backrest of a seat 30, but this is just one of many actuator configurations that this technology can encompass. Any number of actuators can be positioned at various points within a seat, wearable device, or other surface, and a multitude of mounting strategies can be deployed. Additionally, the orientation of the actuators can be configured in many ways.

In an example scenario, the large back actuator 31 shown in FIG. 3 may have a poor transient performance, in which case the static weighting Wₜᵣ_{ᵢ} for the transient signal will typically be set to a larger value than the static weighting Wₛₛ_{ᵢ} for the steady state signal. In this single actuator case, both the transient and steady state signals will be sent to the same drive unit. To calibrate this drive unit, Wₜᵣ_{ᵢ} is set to 2 (+6 dB) and Wₛₛ_{ᵢ} is set to 1 (+0 dB). This example weighting will double the strength of the transient component of the received signal. Moreover, if the scaling factor b is set to 6, this gives the user 12 dB (i.e. 2b) of range to control the signal. If the user were listening to dance music, for example, they may choose to increase the u parameter to boost the transients, or they may decrease the value if they were listening to orchestral music.

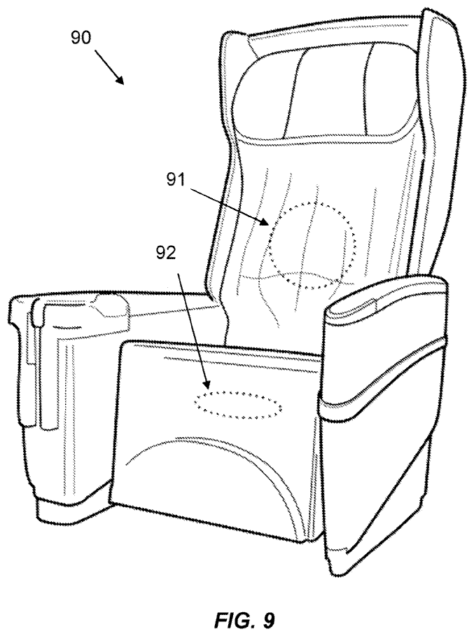

In another example, such as that shown in FIG. 9, where a seat 90 is fitted with more than one actuator the Wₛₛ_{ᵢ} and Wₜᵣ_{ᵢ} values can be used to weight the backrest actuator 91, for instance, to heavily exaggerate the transient component of the signal, while the below seat actuator 92 is weighted to exaggerate or exclusively render the steady state component of the signal. Additionally, floor or wearable leg mounted actuators can be used to mimic the sensation experienced when standing at a venue where high SPL music is being performed. The steady state or rumble effect can be rendered below the user's feet and the whole-body vibration sensation will be similar to the vibration transmitted through the ground and conducted through the feet from high volume bass drivers.

A very simple setup such as in FIG. 3 requires no weighting. The transient signal can be sent with no weighting to drive the backrest driver 31, which is equivalent to setting Gₛₛ_{ᵢ}=0 and Gₜᵣ_{ᵢ}=1 in the combined signal model. The transient signal may go through some corrective equalisation filters to calibrate the performance of the actuator prior to the content rendering stage. Likewise, the steady state signal can be sent with no weighting to drive the actuator below the seat, which is equivalent to setting Gₛₛ_{ᵢ}=1 and Gₜᵣ_{ᵢ}=0 in the combined signal model. Again, the steady state signal may undergo some corrective equalisation prior to the content rendering stage.

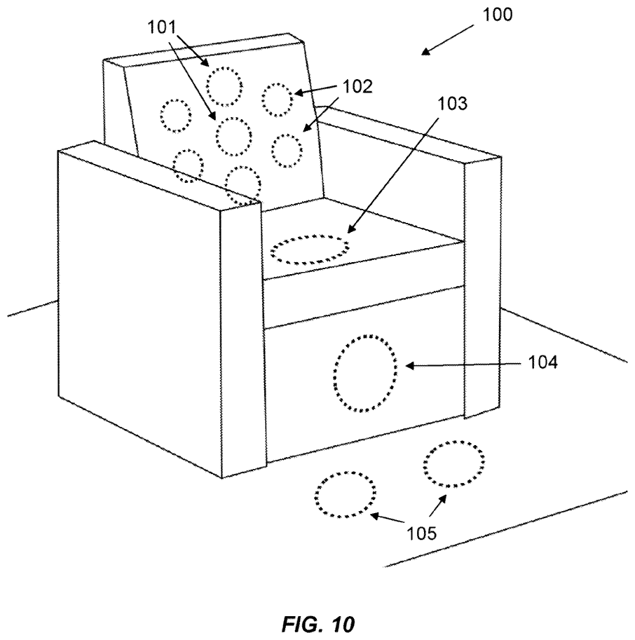

While large mass movers have been shown as a potential haptic actuator for certain solutions, additionally, several smaller acoustic transducers can be fitted to render the tactile augmentation. FIG. 10 illustrates the use of different actuators within a seat 100 according to their location and purpose. The seat backrest contains multiple actuators, with medium actuators 101 located in the region of the occupant's spine supplemented by smaller actuators 102 nearer the periphery. Larger actuators are employed for the below seat 103 and leg regions 104 of the seat, whilst further actuators 105 are embedded in the floor to render a rumble effect below the user's feet. In this instance, it is useful to weight the transient portion of the signal heavily to transducers in closer proximity to the occupant, for instance the transducers 101 closest to the user's spine, to create a tight concentrated transient performance. The steady state component can be weighted to disperse the rumble effect over a large surface area to effectively vibrate the entire seat.

When the haptic processing is implemented as part of a larger multi-loudspeaker system, where some of the drive units are to render signals in the human audible range, there may be a temporal mismatch between the perceived auditory and tactile signals, this can be due to multiple factors, including sound source proximity, actuator speed and the medium of signal transmission. To correct for this, a delay line can be implemented before any of the signals to delay either the tactile signal or the audible signal. Herein, the application of delay for such purpose is referred to as temporal correction.

In summary, an audio signal containing frequencies in the human tactile perception range can be decomposed into complementary transient and steady state components. The initial signal may optionally be frequency band-limited, or input directly with no prior processing. The decomposed tactile signals can be weighted and distributed to a plurality of acoustic transducers designed to render tactile content. The individual tactile signals may be routed directly to output channels or be combined prior to output. A temporal correction may optionally be applied to facilitate integration into a multi-media system. The weighting allows the generated tactile signals to be system agnostic, as they can be rendered over any number of actuators and can accommodate for their transient responses. Alternatively, the user can be given control over the relative weighting of the transient and steady-state signals.

1. A method of generating one or more tactile driving signals from an input signal representative of real-time audio, the method comprising the steps of:
receiving the input signal;
performing transient extraction processing on the input signal to determine a transient component of the real-time audio;
generating a transient tactile signal T(t) and a steady state tactile signal S(t) from the input signal in dependence on the transient extraction processing, wherein the transient tactile signal and the steady state tactile signal are complimentary such that S(t)+T(t)=I(t), where I(t) is the input signal on which transient extraction processing was performed; and,
generating the one or more tactile driving signals in dependence on one or both of the transient tactile signal and the steady state tactile signal.

2. A method according to claim 1, wherein:
performing transient extraction processing comprises deriving a real-time transient estimation value C(t) from the input signal, wherein C(t) has values in the range 0≤C(t)≤1 and is representative of the transient component of the real-time audio; and,
the transient tactile signal T(t) is generated according to T(t)=C(t) I(t) and the steady-state tactile signal S(t) signal is generated according to S(t)=(1−C(t))/(t).

3. A method according to claim 2, wherein C(t) is defined according to the expression:
$$C ( t ) = \sqrt{{P}_{peak} ( t )} - \sqrt{{P}_{avg} ( t )}$$
where Pₚₑₐₖ(t) represents the maxima of the squared audio signal within a time frame of the signal and P_{avg}(t) represents the average of the squared signal as calculated over the same time frame such that Pₚₑₐₖ(t)≥P_{avg}(t) and Pₚₑₐₖ, P_{avg}∈[0:1].

4. A method according to claim 1, wherein the received input signal is band-limited, either naturally or from prior frequency filtering.

5. A method according to claim 1, further comprising the step of frequency filtering the input signal to band-limit the input signal prior to the transient extraction processing, wherein I(t) is the input signal after the filtering.

6. A method according to claim 4, wherein the band-limited input signal is in the frequency range 40 to 250 Hz.

7. A method according to claim 1, wherein the input signal is a multi-channel signal and the method further comprises downmixing the input signal to a single-channel signal before transient extraction processing.

8. A method according to claim 1, wherein the input signal comprises a low-frequency effects (LFE) channel.

9. A method according to claim 1, wherein generating the one or more tactile driving signals comprises applying temporal correction to one or both of the transient tactile signal and the steady state tactile signal.

10. A method according to claim 1, wherein generating the one or more tactile driving signals comprises applying frequency filtering to one or both of the transient tactile signal and the steady state tactile signal.

11. A method according to claim 1, wherein generating the one or more tactile driving signals comprises combining the transient tactile signal and the steady state tactile signal.

12. A method according to claim 11, wherein generating the one or more tactile driving signals further comprises weighting the transient tactile signal and the steady state tactile signal prior to combining them, such that the i^{th} tactile driving signal is generated according to:
$${A}_{i} ( t ) = {G}_{s {s}_{i}} S ( t ) + {G}_{t {r}_{i}} T ( t )$$
where Gₛₛ_{ᵢ} is the weighting applied to the steady state tactile signal and Gₜᵣ_{ᵢ} is the weighting applied to the transient tactile signal to generate the i^{th} tactile driving signal Aᵢ(t), where i≥1.

13. A method according to claim 12, wherein the weighting applied to each of the transient tactile signal and the steady state tactile signal comprises a variable weighting component that is determined from a user input parameter, and a static weighting component.

14. A method according to claim 13, wherein the weighting Gₛₛ_{ᵢ} applied to the steady state tactile signal and the weighting Gₜᵣ_{ᵢ} applied to the transient tactile signal are calculated according to:
$${G}_{s {s}_{i}} = {10}^{\frac{- u b}{20}} + {W}_{s {s}_{i}} ; u ∈ [ - 1 : 1 ]$$
$${G}_{t {r}_{i}} = 1 {0}^{\frac{u b}{20}} + {W}_{t {r}_{i}} ; u ∈ [ - 1 : 1 ]$$
where u is the input user parameter in the range −1 to 1, b is a static scaling factor in decibels that controls the strength of the user parameter, and Wₛₛ_{ᵢ} and Wₜᵣ_{ᵢ} are the static weighting values for the steady state tactile signal and the transient tactile signal respectively for generating the i^{th} tactile driving signal.

15. A method according claim 11, wherein a plurality of different tactile driving signals is generated by applying different weightings to the transient tactile signal and the steady state tactile signal prior to combining them to generate the respective tactile driving signal.

16. A method according to claim 1, further comprising generating one or more acoustic driving signals in the audible frequency range in dependence on the input signal.

17. A computer readable medium comprising computer executable instructions which, when executed on one or more processors of an audio system, causes the system to perform the method of claim 1.

18. An audio system comprising one or more digital signal processors adapted to generate one or more tactile driving signals from an input signal representative of real-time audio by:
receiving the input signal;
performing transient extraction processing on the input signal to determine a transient component of the real-time audio;
generating a transient tactile signal T(t) and a steady state tactile signal S(t) from the input signal in dependence on the transient extraction processing, wherein the transient tactile signal and the steady state tactile signal are complimentary such that S(t)+T(t)=I(t), where I(t) is the input signal on which transient extraction processing was performed; and,
generating the one or more tactile driving signals in dependence on one or both of the transient tactile signal and the steady state tactile signal.

19. An audio system according to claim 18, comprising a user interface for receiving user input parameters.

20. An audio system according to claim 18, comprising one or more tactile transducers for providing haptic feedback, each of the tactile transducers driven by a tactile driving signal of the one or more tactile driving signals.

21. An audio system according to claim 20, wherein each tactile driving signal is generated for optimally driving its respective tactile transducer.

22. An audio system according to claim 20, wherein one or more of the tactile transducers are adapted for use in a seat, or in a wearable device, or in flooring.

23. An audio system according to claim 18, wherein the one or more digital signal processors are further adapted to generate one or more acoustic driving signals in the audible frequency range in dependence on the input signal, and
wherein the audio system further comprises one or more acoustic transducers for providing audible feedback, each of the acoustic transducers driven by an acoustic driving signal of the one or more acoustic driving signals.
